(19) United States
(12) Patent Application Publication
(10) Pub. No.: US 2017/0335949 A1
(43) Pub. Date: Nov. 23, 2017

(54) Vehicle Having an Automatic Transmission and a Manually Actuatable Selector Element

(71) Applicant: Bayerische Motoren Werke Aktiengesellschaft, Muenchen (DE)

(72) Inventors: Christopher ROELLE, Groebenzell (DE); Lenja SOROKIN, Muenchen (DE); Gunnar FRANZ, Ottobrunn (DE)

(21) Appl. No.: 15/671,362

(22) Filed: Aug. 8, 2017

Related U.S. Application Data
(63) Continuation of application No. PCT/EP2016/051482, filed on Jan. 26, 2016.

(30) Foreign Application Priority Data
Feb. 26, 2015 (DE) 10 2015 203 409.7

(51) Int. Cl. F16H 59/02

(52) U.S. Cl. CPC F16H 59/0204; F16H 2059/0221; F16H 2059/0239

(57) ABSTRACT

A vehicle has an automatic transmission and a manually actuatable selector element which is provided for selecting a group of operating modes of the automatic operation. The selector element is additionally provided to switch the vehicle from a vehicle operating mode of non-highly automated driving into a vehicle operating mode of highly automated driving, or vice versa.

### CROSS REFERENCE TO RELATED APPLICATIONS

This application is a continuation of PCT International Application No. PCT/EP2016/051482, filed Jan. 26, 2016, which claims priority under 35 U.S.C. §119 from German Patent Application No. 10 2015 203 409.7, filed Feb. 26, 2015, the entire disclosures of which are herein expressly incorporated by reference.

### BACKGROUND AND SUMMARY OF THE INVENTION

The present invention relates to a vehicle having an automatic transmission, and a manually actuatable selector element which is provided for selecting a group of operating modes (P, R, N, D) of the automatic operation.

Vehicles of the BMW brand with an automatic transmission have a selector lever which is arranged in the region of the center console. In a first position of the selector lever, the individual operating modes of the automatic transmission (reverse driving, neutral, forward driving) which are arranged one behind the other in a first shifting gate can be selected. A shift can be carried out into a sport mode by way of “pivoting to the left” the selector lever, in which mode the individual gears are used up to relatively high rotational speeds and it is possible for the driver to shift the transmission “manually” into a lower gear or into a higher gear by way of pivoting the selector lever forward or rearward (counter to the driving direction).

It is an object of the invention to provide a vehicle with an automatic transmission and a selector lever which has an extended or modified functionality in comparison with known selector levers.

This and other objects are achieved according to the invention by a vehicle having an automatic transmission and a manually actuatable selector element which is provided for selecting a group of operating modes of the automatic transmission. Here, “selecting” is to be understood, in particular, in the sense of “actuating”, that is to say the selector lever is not connected mechanically to the automatic transmission, but merely electrically to a transmission control unit which actuates individual actuators which are provided for shifting individual transmission gears.

The core of the invention consists in that the selector element is additionally provided to shift the vehicle from a “non-highly automated driving” operating mode into a “highly automated driving” operating mode, or vice versa.

“Manual driving” is driving as we know it nowadays. The driver operates the vehicle in relation to its longitudinal and transverse guidance, and in relation to further functions. Even if the longitudinal and transverse guidance can be assisted or also can be partially taken over by way of driver assistance systems, the driver remains responsible for the system. The monitoring of all essential regulating functions are incumbent upon him/her. The important point here is the legal responsibility for safe vehicle guidance which still always remains with the driver, despite all the assistance systems.

Autonomous driving is to be classified at the other “end of the scale”. Highly automated driving is to be classified between manual driving and autonomous driving.

In the case of highly automated driving, a temporary transfer of the responsibility to the regulating technology is possible. The systems of the vehicle guidance are then designed such that said vehicle guidance can assume the responsibility for a defined time in a defined environment (for example, freeways). The driver is then also no longer obliged to monitor the regulating functions. Since, however, situations can still occur owing to technology (for example, failure of the sensor system, confusing traffic situations, etc.), the system can also give the responsibility back to the driver. In order that this can happen, it has to be ensured that the driver can assume the task of driving again within a time window of 5-7 seconds (current state of scientific research at the end of 2014) (that is to say, no sleeping or leaving of the vehicle seat permitted).

The “highly automated driving” operating mode is therefore distinguished by the fact that the driver does not have to continuously monitor the task of driving, at least for a defined time period and in fixed situations (in contrast to driving with the driver assistance functions which are available nowadays). The driver has to remain capable, however, of being able to assume the task of driving again within a “reasonable” time. The “highly automated driving” operating mode can also differ from the “non-automated driving” operating mode by virtue of the fact that the vehicle drives a driving route which is input via a navigation system in a fully automatic manner in the “highly automated driving” operating mode, the vehicle being accelerated and braked and automatically steered via an electronic regulating device.

In contrast to highly automated driving, the technology is so fail-safe during autonomous driving that a sudden assumption of the task of driving by the driver is no longer required, with the result that said type of mobility then more resembles traveling on a train than driving a car.

According to one development of the invention, the abovementioned “group of operating modes” comprises a “driving” operating mode where individual gears of the automatic transmission are shifted in a controlled manner by way of a transmission control electronics system, and a “neutral” operating mode where a non-positive connection between an input and an output of the automatic transmission is interrupted, that is to say between an input shaft and an output shaft of the automatic transmission, as well as a “reverse driving” operating mode where the automatic transmission is shifted into a reverse driving gear.

According to one development of the invention, the selector element has at least one first position or at least one first state which is assigned to the “non-highly automated driving” operating mode.

It is provided, furthermore, that the selector element has at least one second position or at least one second state which is assigned to the highly automated driving operating mode. The at least one first position which is assigned to the non-highly automated driving operating mode differs from the at least one second position which is assigned to the highly automated driving operating mode.

When the at least one first position and the at least one second position are mentioned, this can mean stable mechanical positions which differ from one another. This does not absolutely necessarily have to be the case, however. It is also contemplated that the at least one first position is a monostable position, in such a way that, after the manual deflection from the first position into the second position, the selector element moves back automatically into the at least one first position.

It is provided according to one development of the invention that, when the selector element is situated in the at least one first position or the at least one first state, the vehicle is situated in the “non-highly automated driving” operating state and the automatic transmission is situated in the “driving” or “neutral” or “reverse driving” operating mode, or in a parked state.

In a similar manner to a conventional vehicle with an automatic transmission, it can be provided that the automatic transmission can be shifted between the driving, neutral or reverse driving operating modes out of the at least one first position of the selector element by way of deflection of the selector element in the direction of a first actuating gate. The first actuating gate can run, for example, parallel to a longitudinal direction of the vehicle.

If the at least one first position is a monostable position, it can be provided that shifting can be carried out into the neutral state out of the driving operating mode by way of pivoting of the selector element in a first direction of the actuating gate. It can be provided, furthermore, that shifting can be carried out directly into the reverse driving operating mode by way of a pressure point being overcome, that is to say by way of further pivoting of the selector element in the same direction (that is to say, without it being necessary for the selector element to first of all be pivoted back into the monostable position again).

It can be provided, furthermore, that shifting can be carried out directly into the driving operating mode out of the “reverse driving” operating mode by way of opposite pivoting of the selector element in the actuating gate into the neutral operating mode or by way of a pressure point of the selector element being overcome, that is to say by way of further pivoting of the selector element.

It is provided according to one development of the invention that the automatic transmission can be shifted over into the at least one second position which is assigned to the highly automated driving operating mode out of the at least one first position which is assigned to the non-highly automated driving operating mode by way of deflection of the selector element in a (pivoting) direction transversely with respect to the first actuating gate.

In other words, in the non-highly automated driving operating mode, the automatic transmission can be shifted between the driving, neutral or reverse driving operating modes by way of forward or rearward pivoting of the selector element and can be shifted into the highly automated driving operating mode by way of pivoting of the selector element, for example, in the vehicle transverse direction to the right or in the vehicle transverse direction to the left.

The selector element according to the invention can be arranged in the region of a center console of the vehicle. This does not necessarily have to be the case, however. It would also be possible in principle for the selector element to be arranged so as to project laterally from the steering column in a comparable manner to an indicator lever or a “windshield wiper lever”.

If the at least one second position of the selector element is a mechanically stable position, it can be provided that the selector element can be moved out of the at least one second position in the direction of a second actuating gate. The second actuating gate can run parallel to the first actuating gate (for example, parallel to the vehicle longitudinal direction).

It is provided according to one development of the invention that predefined functions of the highly automated driving vehicle operating mode can be selected by way of movement of the selector element in the second actuating gate. For example, the driver can give a signal to an electronic regulating apparatus that an overtaking operation is to be initiated by way of movement (for example, pivoting) of the selector element in the second actuating gate.

It is provided according to one development of the invention that the automatic transmission can be shifted over into a third position or into a third state out of the at least one first position by way of deflection of the selector element in a direction transversely with respect to the first actuating gate. It can be provided, furthermore, that the automatic transmission can be shifted over from a current gear into a next higher gear or into a next lower gear by way of movement of the selector element out of the third position or the third state in a third actuating gate of the selector element, which third actuating gate is parallel to the first actuating gate. This vehicle operating mode can be designed as a sport mode where it is possible for the automatic transmission to be shifted up or down “manually”, that is to say by way of actuating or pivoting of the selector element in the third actuating gate.

If the selector element is a completely monostable selector element, it can be provided that the at least one first position corresponds to the at least one second position and the optionally at least one third position, and that the first actuating gate and the second actuating gate and the possibly present third actuating gate are also identical.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram illustrating a first exemplary embodiment in accordance with the invention.

FIG. 2 is a schematic diagram illustrating a second exemplary embodiment in accordance with the invention.

### DETAILED DESCRIPTION OF THE DRAWINGS

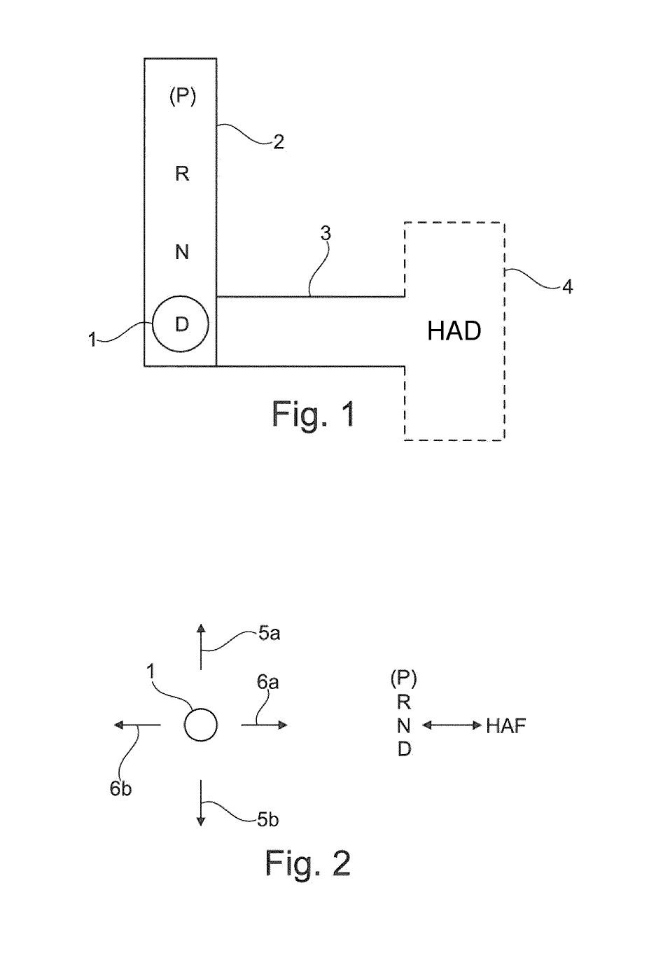

FIG. 1 shows a “shifting gate diagram” of a vehicle with an automatic transmission, it being possible for the vehicle to be operated selectively in a “non-highly automated driving” or “highly automated driving” operating mode.

In the “non-highly automated driving” vehicle operating mode, shifting can be carried out between individual transmission operating modes D, N, R by means of a selector element 1 (shown in a merely highly diagrammatic manner here). The transmission operating mode D is the forward driving mode, N is the neutral state where the power flow between an input shaft and an output shaft of the automatic transmission is interrupted, and R is the reverse driving mode.

An operating element, for example a button, can be provided on the selector element. By actuating the operating element, the automatic transmission can be shifted into a parked state (P). As an alternative, it can be provided that the parked state can be engaged by way of movement of the selector element into an assigned parked position P.

As has already been mentioned, shifting over can be carried out between the individual transmission operating modes R, N, D and optionally P by way of movement (for example, by way of pivoting) of the selector lever in a first shift gate 2. The first shift gate 2 can be, for example, parallel to a longitudinal direction of the vehicle.

If the vehicle is situated in the “non-highly automated driving” operating mode in one of the transmission operating modes R, N, D and optionally P, shifting can be carried out into a “highly automated driving” (HAD for short) vehicle operating mode by way of pivoting of the selector element 1 in a direction 3 which is transverse with respect to the first actuating gate 2.

It can be provided that, as indicated in FIG. 1, the selector lever 1 has at least two stable positions, namely at least one stable position in the first actuating gate 2 and one second stable position which is assigned to the highly automated driving (HAD) vehicle operating mode.

If the selector element is situated in its “right-hand position” which is assigned to the highly automated driving (HAD) vehicle operating mode, it can thus be provided that the selector lever can be actuated in a second actuating gate 4. In the exemplary embodiment which is shown in FIG. 1, the second actuating gate 4 is parallel to the first actuating gate 2, that is to say parallel to a vehicle longitudinal direction. It can be provided that predefined functions of the highly automated driving vehicle operating mode can be selected by way of movement of the selector element 1 in the second actuating gate 4, that is to say by way of forward pivoting or rearward pivoting of the actuating element 1 in the second actuating gate. It can be provided that, for example, a signal from the driver for an overtaking operation which is then to be performed by a regulating electronics system in a fully automated manner can be given by way of forward pivoting of the selector element 1 in the second actuating gate 4.

In the exemplary embodiment of FIG. 2, a selector element 1 which is of a completely monostable configuration is shown in a diagrammatic manner. That is to say, the selector element 1 returns automatically into its “rest position” which is shown in FIG. 2 after every deflection of the selector element 1.

If the vehicle is situated in the non-highly automated driving vehicle operating mode, shifting between the individual automatic transmission modes (P), R, N, D can be carried out by way of pivoting of the selector element 1 in the direction of the longitudinal axis of the vehicle, that is to say in the direction of the arrows 5a, 5b, which corresponds to the non-highly automated driving vehicle operating mode. Starting from said vehicle operating mode, shifting over into the highly automated driving (HAD) vehicle operating mode can be carried out by way of pivoting of the selector element to the right, that is to say in the direction of the arrow 6a. As an alternative to this, it might of course also be provided that shifting into the highly automated driving vehicle operating mode can be carried out by way of pivoting to the left, that is to say in the direction of the arrow 6b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle, comprising:
an automatic transmission; and
a manually actuatable selector element which is provided for selecting a group of operating modes of the automatic operation, wherein
the selector element is additionally provided to shift the vehicle from a non-highly automated driving vehicle operating mode into a highly automated driving vehicle operating mode, or vice versa.

2. The vehicle as claimed in claim 1, wherein the group of operating modes comprises:
a driving operating mode where individual gears of the automatic transmission are shifted in a controlled manner via a transmission control electronics system;
a neutral operating mode where a non-positive connection between an input and an output of the automatic transmission is interrupted; and
a reverse driving operating mode where the automatic transmission is shifted into a reverse driving gear.

3. The vehicle as claimed in claim 2, wherein the selector element has at least one first position which is assigned to the non-highly automated driving operating mode.

4. The vehicle as claimed in claim 3, wherein
the selector element has at least one second position which is assigned to the highly automated driving operating mode,
at least one first position which is assigned to the non-highly automated driving operating mode differs from the at least one second position which is assigned to the highly automated driving operating mode.

5. The vehicle as claimed in claim 4, wherein the at least one first position is a monostable position such that, after being deflected manually into the second position, the selector element returns automatically into the at least one first position.

6. The vehicle as claimed in claim 4, wherein the at least one first position and the second position are in each case stable positions, in which the selector element can remain non-actuated.

7. The vehicle as claimed in claim 3, wherein if the selector element is situated in the first position:
the vehicle is situated in the non-highly automated driving operating state, and
the automatic transmission is situated in the
driving,
neutral,
reverse driving operating mode, or
in a parked state.

8. The vehicle as claimed in claim 5, wherein if the selector element is situated in the first position:
the vehicle is situated in the non-highly automated driving operating state, and
the automatic transmission is situated in the
driving,
neutral,
reverse driving operating mode, or
in a parked state.

9. The vehicle as claimed in claim 6, wherein if the selector element is situated in the first position:
the vehicle is situated in the non-highly automated driving operating state, and
the automatic transmission is situated in the
driving,
neutral,
reverse driving operating mode, or
in a parked state.

10. The vehicle as claimed in claim 4, wherein the automatic transmission is shiftable over between the driving, neutral or reverse driving operating modes out of the at least one first position by way of deflection of the selector element in a direction of a first actuating gate.

11. The vehicle as claimed in claim 10, wherein the first actuating gate is parallel to a longitudinal direction of the vehicle.

12. The vehicle as claimed in claim 11, wherein the automatic transmission is shiftable into the at least one second position, which is assigned to the highly automated driving operating mode, out of the at least one first position, which is assigned to the non-highly automated driving operating mode, by way of deflection of the selector element in a direction transversely with respect to the first actuating gate.

13. The vehicle as claimed in claim 1, wherein the selector element is arranged in the region of a center console of the vehicle.

14. The vehicle as claimed in claim 4, wherein the selector element is moveable out of the at least one second position in the direction of a second actuating gate which is parallel to the first actuating gate.

15. The vehicle as claimed in claim 14, wherein predefined functions of the highly automated driving vehicle operating mode are selectable by the movement of the selector element in the second actuating gate.

16. The vehicle as claimed in claim 15, wherein a signal for initiating an overtaking operation is generated by way of movement of the selector element in the second actuating gate.

17. The vehicle as claimed in claim 1, wherein the automatic transmission is shiftable over into a third position out of the at least one first position by way of deflection of the selector element in a direction transversely with respect to the first actuating gate.

18. The vehicle as claimed in claim 17, wherein the automatic transmission is shiftable from a current gear into a next higher gear or into a next lower gear by way of movement of the selector element out of the third position in a third actuating gate which is parallel to the first actuating gate.

19. The vehicle as claimed in claim 4, wherein the automatic transmission is shiftable over into a third position out of the at least one first position by way of deflection of the selector element in a direction transversely with respect to the first actuating gate.

20. The vehicle as claimed in claim 19, wherein the automatic transmission is shiftable from a current gear into a next higher gear or into a next lower gear by way of movement of the selector element out of the third position in a third actuating gate which is parallel to the first actuating gate.
